(19) United States
(12) Patent Application Publication
(10) Pub. No.: US 2005/0226349 A1
(43) Pub. Date: Oct. 13, 2005

(54) Down conversion methodology and topology which compensates for spurious response

(76) Inventor: Tajinder Manku, WATERLOO, ONTARIO (CA)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/505,414

(22) PCT Filed: Feb. 25, 2003
(86) PCT No.: PCT/CA03/00257

§ 371 Date: May 4, 2005

(51) Int. Cl. H04L 27/06

(52) U.S. Cl. 375/316

(57) ABSTRACT

There is a need for an inexpensive, high-performance, fully-integrable, multistandard transceiver, which suppresses spurious noise signals. The invention provides a topology that satisfies this need, providing a first mixer for receiving an input signal x(t), and mixing it with a multi-tonal mixing signal φ1 to generate an output signal φ1 x(t), and providing a second mixer for receiving the φ1 x(t) signal, and mixing it with a mono-tonal mixing signal φ2, to generate an output signal φ1 φ2 x(t). The two mixing signals emulate an LO signal because φ1*φ2 has significant power at the frequency of the LO signal being emulated. The topology also includes a power measurement circuit for measuring the power of the output signal φ1 φ2 x(t). This power output signal is used to vary the characteristics of the mono-tonal mixing signal φ2 to reduce the power level of said output signal.

The present invention relates generally to communications, and more specifically to a method and apparatus of demodulating RF (radio frequency) signals which compensates for spurious response. The preferred embodiment of the invention satisfies the need for an inexpensive, high-performance, fully-integrable, multi-standard receiver.

### BACKGROUND OF THE INVENTION

Many communication systems modulate electromagnetic signals from baseband to higher frequencies for transmission, and subsequently demodulate those high frequencies back to their original frequency band when they reach the receiver. The original (or baseband) signal may be, for example: data, voice or video. These baseband signals may be produced by transducers such as microphones or video cameras, may be computer generated, or may be transferred from an electronic storage device. In general, the high frequencies provide longer range and higher capacity channels than baseband signals, and because high frequency signals can effectively propagate through the air, they can be used for wireless transmissions as well as hard-wired or wave guided channels.

All of these signals are generally referred to as RF signals, which are electromagnetic signals; that is, waveforms with electrical and magnetic properties within the electromagnetic spectrum normally associated with radio wave propagation.

Wired communication systems which employ such modulation and demodulation techniques include computer communication systems such as local area networks (LANs), point-to-point communications, and wide area networks (WANs) such as the Internet. These networks generally communicate data signals over electrically conductive or optical fibre channels. Wireless communication systems which may employ modulation and demodulation include those for public broadcasting such as AM and FM radio, and UHF and VHF television. Private communication systems may include cellular telephone networks, personal paging devices, HF radio systems used by taxi services, microwave backbone networks, interconnected appliances under the Bluetooth standard, and satellite communications. Other wired and wireless systems which use RF modulation and demodulation would be known to those skilled in the art.

Most RF receivers use the “super-heterodyne” topology, which provides good performance in a limited scope of applications, such as in public-broadcast FM radio receivers. As will be explained, the super-heterodyne's design limitations make its use in more sophisticated modern applications expensive, and its performance poor.

The super-heterodyne receiver uses a two-step frequency translation method to convert an RF signal to a baseband signal. FIG. 1 presents a block diagram of a typical super-heterodyne receiver 10. The mixers labelled M1 12 and M2 14 are used to translate the RF signal to baseband or to some intermediate frequency (IF). The balance of the components amplify the signal being processed and filter noise from it.

The RF band pass filter (BPF1) 18 first filters the signal coming from the antenna 20 (note that this band pass filter 18 may also be a duplexer). A low noise amplifier 22 then amplifies the filtered antenna signal, increasing the strength of the RF signal and reducing the noise figure of the receiver 10. The signal is next filtered by another band pass filter (BPF2) 24 usually identified as an image rejection filter. The signal then enters mixer M1 12 which multiplies the signal from the image rejection filter 24 with a periodic signal generated by the local oscillator (LO1) 26. The mixer M1 12 receives the signal from the image rejection filter 24 and translates it to a lower frequency, known as the first intermediate frequency (IF1).

Generally, a mixer is a circuit or device that accepts as its input two different frequencies and presents at its output:
(a) a signal equal in frequency to the sum of the frequencies of the input signals;
(b) a signal equal in frequency to the difference between the frequencies of the input signals; and
(c) the original input frequencies.
   The typical embodiment of a mixer is a digital switch which may generate significantly more tones than stated above.

The IF1 signal is next filtered by a band pass filter (BPF3) 28 typically called the channel filter, which is centred around the IF1 frequency, thus filtering out the unwanted products of the first mixing processes; signals (a) and (c) above. This is necessary to prevent these signals from interfering with the desired signal when the second mixing process is performed.

The signal is then amplified by an intermediate frequency amplifier (IFA) 30, and is mixed with a second local oscillator signal using mixer M2 14 and local oscillator (LO2) 32. The second local oscillator LO2 32 generates a periodic signal which is typically tuned to the IF1 frequency. Thus, the signal coming from the output of M2 14 is now at baseband, that is, the frequency at which the signal was originally generated. Noise is now filtered from the desired signal using the low pass filter LPF 38, and the signal is passed on to some manner of presentation, processing or recording device. For example, in the case of a radio receiver, this might be an audio amplifier, while in the case of a computer modem this may be an analogue to digital convertor.

Note that the same process can be used to modulate or demodulate any electrical signal from one frequency to another.

The main problems with the super-heterodyne design are:
it requires expensive off-chip components, particularly band pass filters 18, 24, 28, and low pass filter 38;
the off-chip components require design trade-offs that increase power consumption and reduce system gain;
image rejection is limited by the off-chip components, not by the target integration technology;
isolation from digital noise can be a problem; and
it is not fully integratable.

The band pass and low pass filters 18, 24, 28 and 38 used in super-heterodyne systems must be high quality devices, so electronically tunable filters cannot be used. As well, the only way to use the super-heterodyne system in a multi-standard/multi-frequency application is to use a separate set of off-chip filters for each frequency band.

Direct-conversion transceivers attempt to perform up and down conversion in a single step, using one mixer and one local oscillator. In the case of down-conversion to baseband, this requires a local oscillator (LO) with a frequency equal to that of the input RF signal. If the LO signal of a direct conversion receiver leaks into the signal path, it will also be demodulated to baseband along with the input signal, causing interference. This LO leakage problem limits the utility of direct-conversion transceivers.

One of the current problems in the art is to develop effective receivers that can adapt to the varying requirements caused either by changing reception conditions, or even changing standards during the use of the device. For cellular telephones and similar consumer items, it is desirable to have receivers that can be fully integrated onto inexpensive, low power integrated circuits (ICs).

A continuing desire to implement lower-cost, more power-efficient receivers has led to intensive research into the use of highly integrated designs; an increasingly important aspect for portable systems, including cellular telephone handsets. This has proven especially challenging as the frequencies of interest in the wireless telecommunications industry (especially low-power cellular/micro-cellular voice/data personal communications systems) have risen above those used previously (approximately 900 MHz) into the spectrum above 1 GHz.

However, none of the attempts made to date have met with much success. Receiver designs which are highly integrated typically have significant noise and quality problems. As well, few make any attempt at all to address transient or spurious noise problems.

Thus, there is a need for a method and apparatus for modulation and demodulation which addresses the problems above. It is desirable that this design be fully-integratable, inexpensive and high performance. As well, it is desirable that this design be easily applied to multi-standard/multi-frequency applications.

### SUMMARY OF THE INVENTION

It is therefore an object of the invention to provide a novel method and system of modulation and demodulation which obviates or mitigates at least one of the disadvantages of the prior art.

One aspect of the invention is defined as a demodulator circuit for emulating the down conversion of an input signal x(t) with a local oscillator (LO) signal, the demodulator circuit comprising: a first mixer for receiving the input signal x(t), and mixing the input signal x(t) with a multi-tonal mixing signal φ1, to generate an output signal φ1 x(t); a second mixer for receiving the signal φ1 x(t) as an input, and mixing the signal φ1 x(t) with a mono-tonal mixing signal φ2, to generate an output signal φ1 φ2 x(t); a first signal generator for generating the multi-tonal mixing signal φ1; a second signal generator for generating the mono-tonal mixing signal φ2, where φ1* φ2 has significant power at the frequency of the local oscillator signal being emulated; and a power measurement circuit for measuring the power of the output signal φ1 φ2 x(t); the second signal generator receiving a power level signal output from the power measurement circuit, and varying the characteristics of the mono-tonal mixing signal φ2 to reduce the power level of the output signal φ1 φ2 x(t).

Another aspect of the invention is defined as a method of emulating the demodulation of an input signal x(t) to the product of the input signal with a local oscillator (LO) signal, the method comprising the steps of: generating a multi-tonal mixing signal φ1; generating a mono-tonal mixing signal φ2, where φ1*φ2 has significant power at the frequency of the local oscillator signal being emulated, and neither of the φ1 nor the φ2 having significant power at the frequency of the input signal x(t), the LO signal being emulated, or an output signal φ1 φ2 x(t); mixing the input signal x(t) with the multi-tonal mixing signal φ1, to generate an output signal φ1 x(t); mixing the signal φ1 x(t) with the mono-tonal mixing signal φ2, to generate the output signal φ1 φ2 x(t); measuring the power of the output signal φ1 φ2 x(t); and adjusting the characteristics of the mono-tonal mixing signal φ2 to minimize the power of the output signal φ1 φ2 x(t).

### BRIEF DESCRIPTION OF THE DRAWINGS

These and other features of the invention will become more apparent from the following description in which reference is made to the appended drawings in which:

FIG. 1 presents a block diagram of a super-heterodyne system as known in the art;

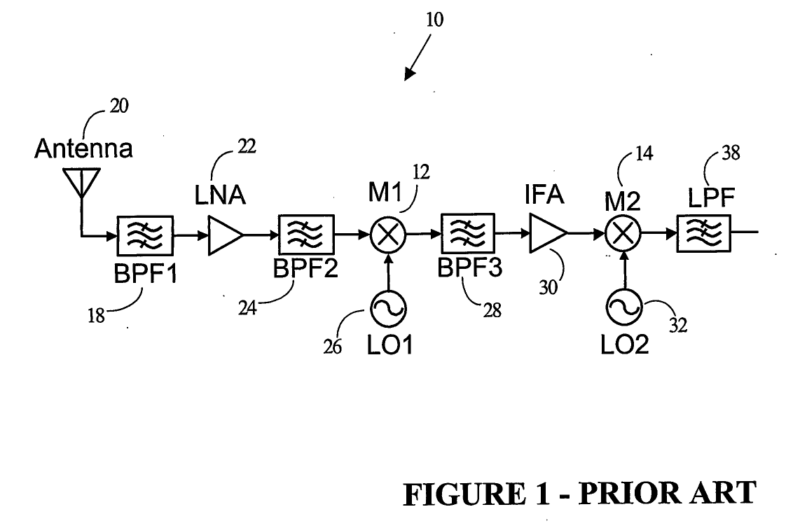

FIG. 2 presents a block diagram of a demodulator topology in a broad embodiment of the invention;

FIG. 3 presents a timing diagram of a set of virtual local oscillator (VLO) mixing signals in an embodiment of the invention;

FIG. 4 presents a frequency spectrum analysis demonstrating a possible noise problem;

FIG. 5 presents a block diagram of an exemplary demodulator topology in an embodiment of the invention;

FIG. 6 presents a block diagram of an exemplary frequency control circuit, in an embodiment of the invention;

FIG. 7 presents a graph of an exemplary relationship between power and control, signal a, in an embodiment of the invention;

FIG. 8 presents a block diagram of an exemplary arrangement for the frequency control circuit and an automatic gain control (AGC) circuit, in an embodiment of the invention;

FIG. 9 presents a block diagram of the exemplary frequency control circuit of FIG. 6, identifying which components which should hold their state while the AGC circuit is operating, and which should not; and

FIG. 10 presents a flow chart of a method of implementing the invention.

### DETAILED DESCRIPTION OF THE INVENTION

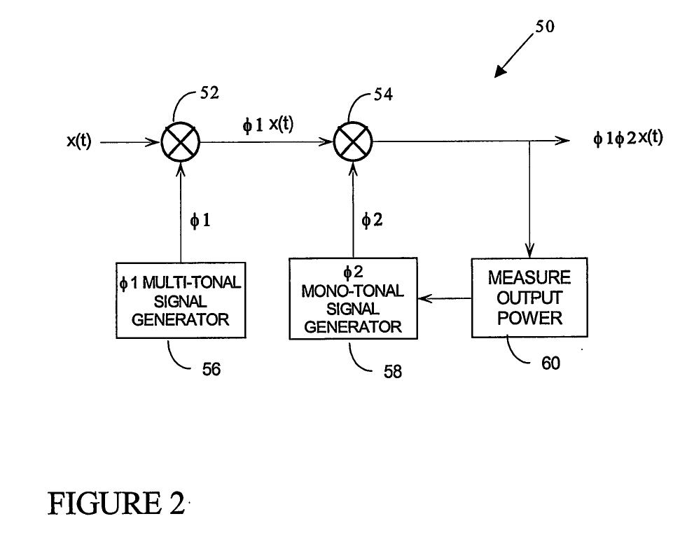

A circuit which addresses a number of the objects outlined above is presented as a block diagram in FIG. 2. This figure presents a demodulator topology 50 in which an input signal x(t) is down-converted by mixing it with two mixing signals φ₁ and φ₂. As will be described, these two mixing signals are φ₁ and φ₂ are very different from mixing signals used in normal two-step conversion topologies (such as superheterodyne topologies). The main difference from the direct-conversion approach is that two mixing signals of the invention are used to emulate the single mixing signal, and they do this without the usual shortcomings of direct-conversion, such as self-mixing.

As shown in FIG. 2, the input signal x(t) is mixed with a multi-tonal mixing signal φ₁ using a first mixer 52 (multi-tonal, or non-mono-tonal, refers to a signal having more than one fundamental frequency tone. Mono-tonal signals have one fundamental frequency tone and may have other tones that are harmonically related to the fundamental tone). The resulting signal, φ1 x(t), is then mixed with a mono-tonal signal φ₂ by means of a second mixer 54, generating an output signal φ1 φ2 x(t). These mixing signals φ1 and φ2 are generally referred to herein as “virtual local oscillator” (VLO) signals as they emulate a local oscillator signal; the product φ1*φ2 having significant power at the frequency of a local oscillator signal being emulated. In the preferred embodiment, neither φ1 nor φ2 have significant power at the frequency of the input signal x(t), the LO signal being emulated, or the output signal φ1 φ2 x(t), but these restrictions can be somewhat relaxed. Mixing signals with such characteristics greatly resolve the problem of self-mixing because the VLO signals simply do not have significant power at frequencies that will appear in the output signal.

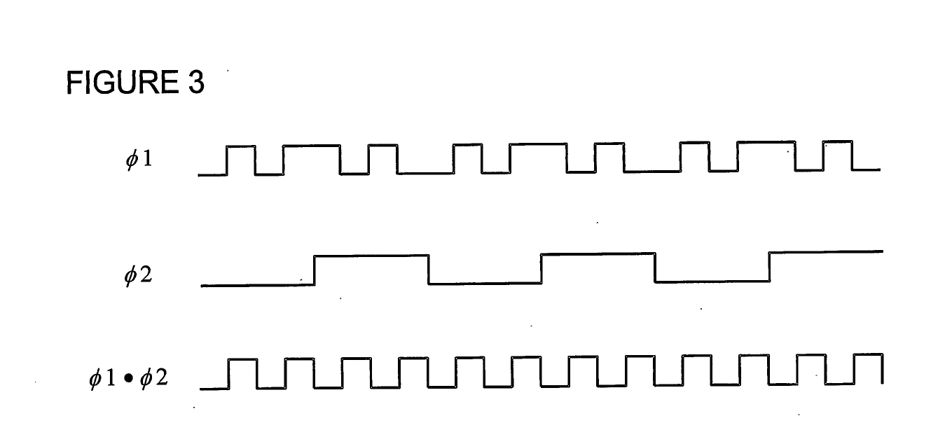

These VLO signals are described in greater detail hereinafter, but an exemplary pair of φ1 and φ2 mixing signals is presented in FIG. 3, plotted in amplitude versus time. It is important to note from FIG. 3 that:
1. φ1 is not mono-tonal (it is multi-tonal);
2. φ2 is mono-tonal;
3. that the product of φ1 and φ2; that is φ1*φ2, is clearly equivalent to the LO signal being emulated. Thus, the output of this demodulation topology, φ1 φ2 x(t), will be equal to the output of a hypothetical LO*x(t) down converter; and
4. that neither of φ1 nor φ2 have significant power at the frequency of the LO signal being emulated.
   It is also important to note that at no point in the operation of the circuit is an actual “φ1*φ2” signal ever generated and if it is, only an insignificant amount is generated. The mixers 52, 54 receive separate φ1 and φ2 signals, and mix them with the input signal x(t) using different physical components. Hence, there is no LO signal which may leak into the circuit.

Looking at one cycle of these mixing signals from FIG. 3 the generation of the φ1*φ2 signal is clear:

| φ1 | φ2 | φ1 * φ2 |
|---|---|---|
| LO | LO | LO |
| HI | LO | HI |
| LO | LO | LO |
| HI | LO | HI |
| HI | HI | LO |
| LO | HI | HI |
| HI | HI | LO |
| LO | HI | HI |

These mixing signals can be generated in many ways, a number of which are described in co-pending patent applications (see for example, co-pending patent applications filed under PCT International Application Serial Nos. PCT/CA00/00994, PCT/CA00/00995 and PCT/CA00/00996). The multi-tonal signal generator 56, for example, can consist of an oscillator operating at a fixed frequency and a linear feedback shift register (LFSR) circuit. Such LFSR circuits are often used to generate similar sequences in CDMA (code division multiple access) communication systems. The mono-tonal signal generator 58, of course, could consist simply of an oscillator.

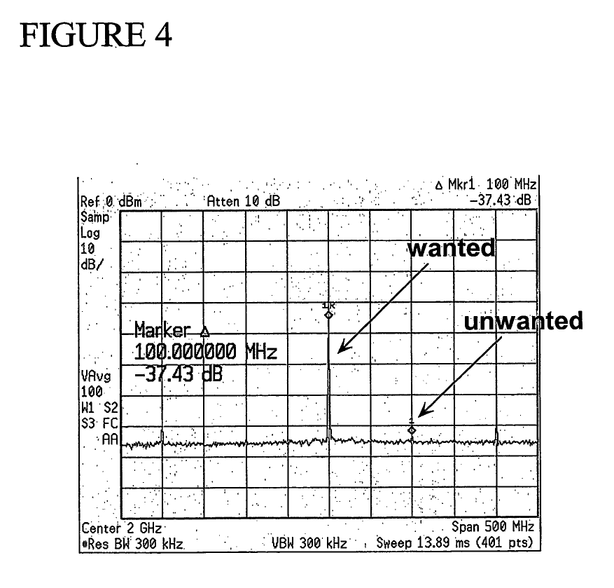

While the use-of VLO mixing signals is very effective, there will be power generated in places other than the RF carrier frequency; “unwanted power” which can be seen in the frequency spectrum test data of FIG. 4. This amount of unwanted power can be controlled via the time delay and frequency of signal φ2. The unwanted power will down convert signals located at the “unwanted power frequencies”. For example, if there is unwanted power at 2100 MHz and there is an out of band RF signal at 2100 MHz, this RF signal will be down converted on top of the wanted signal. However, this down converted power will be attenuated by the difference between “the power of the wanted” minus “the power of the unwanted” (for FIG. 4 this is ˜37 dB). We refer to this difference herein as WmU (Wanted minus Unwanted).

If RFwanted denotes the wanted RF power, the total amount of power at baseband is approximately:
BBpower=RFwanted+10\hat{ }(−WmU/10)*RFunwanted (1)

There are two straightforward ways to fix this problem:
1. adjusting the time delay of φ2, thereby modifying the value of WmU; or
2. adjusting the frequency of φ2 such that the RFunwanted tone does not fall on top of the wanted signal at baseband.
   In either approach the BBpower is minimized as a function of the variables in 1 or 2. The document addresses solution 2, but can equally apply to 1, by renaming variables.

Accordingly, the topology of FIG. 2 is provided with a power measurement circuit 60 for measuring the power of said output signal φ1 φ2 x(t) at the baseband frequency. This power measurement circuit 60 feeds back to the mono-tonal signal generator 58 and is used to manipulate the parameters of the φ2 mixing signal to minimize the power of the output signal φ1 φ2 x(t). In general, any parameter of φ2 could be manipulated depending on the design parameters of the circuit and the nature of the noise that is to be suppressed. In the preferred embodiment described hereinafter, the focus is on manipulating the frequency of the φ2 signal, but phase, amplitude or wave shape could also be manipulated.

The nature of the parameter of the φ2 signal being manipulated will also dictate the design of the mono-tonal signal generator 58. If the frequency of the φ2 signal is being manipulated, the mono-tonal signal generator 58 can simply consist of a voltage controller oscillator (VCO) in conjunction with a phase-locked loop (PLL).

While this circuit contains many components that are similar to commonly used demodulation topologies, it uses them in a unique way. Thus, this circuit:
1. allows an input signal x(t) to be down-converted using a completely integratable circuit;
2. does not use mixing signals that contain significant power at the frequency of the local oscillator signal being emulated. Thus, the frequency translation is still effected, but self-mixing and unwanted mixing products are avoided; and
3. is particularly convenient when applied to the development of multi-standard/multi-frequency devices because no filters are required, and because a wide variety of mixing signals can easily be generated and manipulated. A digital signal processor (DSP) for example, could be used to coordinate mixing signals for a large number of standards and frequencies in a single device.
   Other advantages of the invention will also become clear from the other embodiments of the invention described hereinafter.

Note that particular design parameters for the two mixers 52 and 56 would be clear to one skilled in the art, having the typical properties of an associated noise figure, linearity response, and conversion gain. The selection and design of these mixers would follow the standards known in the art.

The power measurement device 60 may also one of many known in the art. Power measurement is often provided as an extra output, for example, in RF amplifiers as an RSSI (received-signal strength indicator) output.

Though FIG. 2 implies that various elements are implemented in analogue form, they can also be implemented in digital form. The mixing signals are typically presented herein in terms of binary 1s and 0s, however, bipolar waveforms, ±1, may also be used. Bipolar waveforms are typically used in spread spectrum applications because they use commutating mixers which periodically invert their inputs in step with a local control signal (this inverting process is distinct from mixing a signal with a local oscillator directly).

A number of other embodiments of the invention will now be described.

### DESCRIPTION OF PREFERRED EMBODIMENTS OF THE INVENTION

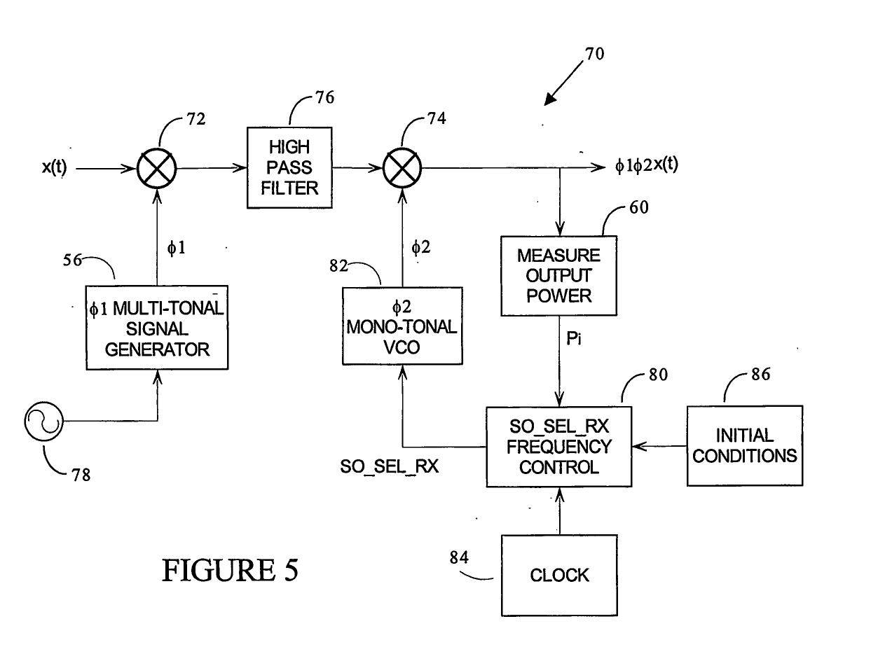

The preferred embodiment of the invention is presented as a block diagram in FIG. 5. At the core, this topology consists of two mixers 72, 74 connected together via a high pass filter (HPF) 76. At the LO ports of the two mixers 72, 74 VLO mixing signals φ1 and φ2 are applied such that the incoming RF signal, x(t), is multiplied by a signal having significant power at the RF carrier frequency of x(t), downconverting it to baseband.

The first mixer 72 is preferably an active mixer, and the second mixer 74, a passive mixer. Active mixers are distinct from passive mixers in a number of ways:
1. they provide conversion gain; thus, an active mixer can replace the combination of a low noise amplifier and a passive mixer;
2. active mixers provide better isolation between the input and output ports because of the impedance of the active components; and
3. active mixers allow a lower powered mixing signal to be used, reducing the noise that results when the mixing signal is generated.

In spite of these advantages, the application of active mixers in modulation and demodulation topologies is still problematic. Because active mixers are non-linear devices, they generate more “1/f” noise and produce second-order distortion. This noise is called 1/f noise because its power spectra is generally inversely proportional to the frequency—in other words, the power of the noise signal is greater, close to DC (direct current).

In the topology of the invention, this second-order distortion is removed using the high pass filter (HPF) 76. Because the second mixer 74 is a passive mixer and it operates at a relatively lower mixing frequency, it introduces significantly less second-order distortion into the signal. Thus, this topology provides the benefits of active mixing, without introducing second-order distortion into the output signal.

As noted above, the multi-tonal signal generator 56 can be implemented in a manner known in the art. In general, the multi-tonal signal generator 56 will be fed with an oscillator signal of some sort, as known in the art. Note that if the invention is applied in a multi-band application, for which it is well suited, it may be necessary for the multi-tonal signal generator 56 and oscillator 78 to have a broad range of operation.

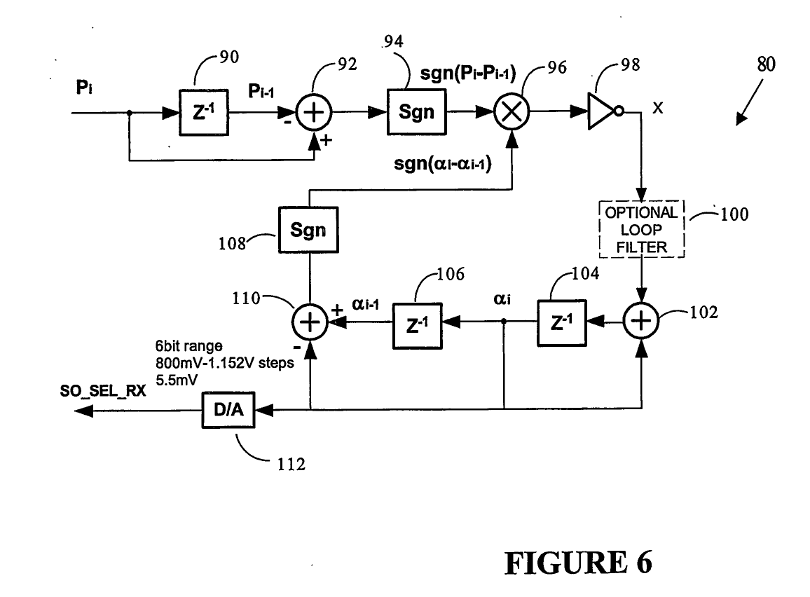

The components that generate the φ2 mixing signal are presented as a block diagram in FIG. 5, but are described in greater detail with respect to FIGS. 6-10. At the heart of the φ2 generation circuit lies the frequency control circuit 80. Its role is to receive data on the output power from mixer 74 and the power measuring device 60, and to use this data to manipulate the frequency of mixing signal φ2 to minimize this output power. In the preferred embodiment, mixing signal φ2 is generated using a voltage controlled oscillator (VCO) 82, so the frequency control circuit 80 is simply designed to adjust the output of the VCO 82 within the desired frequency range for φ2. By minimizing the power at baseband as a function of φ2, this solution pushes the unwanted power to a location in which it does not cause problems.

In the preferred embodiment, the power measuring device 60 provides a digital-byte output, but of course, it could also be provided in other forms. The frequency controller 80 receives these digital power measurement signals and determines whether the output power level is rising or falling. It does this simply by comparing the current power level with an earlier, stored power level. If the power level has fallen since this earlier, stored power level was received, then it is clear that any incremental frequency adjustments the frequency controller 80 has been directing the VCO 82 to make, are progressing toward a minimum power level. The frequency controller 80 should therefore advise the VCO 82 to continue adjusting the frequency of φ2 in the same manner.

If the power level has risen since the earlier, stored power level was received, then clearly the frequency controller 80 and VCO 82 are making adjustments away from the minimum power level, so the sense of the adjustments should be inverted (i.e. if positive increments in the frequency of φ2 were being made when a rise in power was detected, then these should be switched to negative frequency adjustments. Conversely, if negative adjustments were being made when a rise in power was detected, then these should be switched to positive frequency adjustments). Any circuit which performs a similar kind of power analysis and φ2 frequency adjustment could be used.

In the preferred embodiment described hereinafter, an external clock 84 is used to supervise the sampling of power measurements, and set the time differential between the stored power measurement and the current power measurement. This signal could also be provided by a micro-controller, digital signal processor or similar processing device, and does not have to be uniformly periodic.

Also in the preferred embodiment, delay latches and feedback loops are used in the frequency controller 80. It is therefore necessary to set the initial conditions for the frequency controller 80 using some manner of control circuit 86. Like the external clock 84, the functionality of this initial condition control circuit 86 could be provided by a micro-controller, digital signal processor or similar processing device, or could simply be provided using gate logic or an ASIC (application specific integrated circuit).

The frequency control circuit 80 may also take many forms. In a simple implementation, it may consist of several simple logic and linear components. Alternatively, it may be implemented almost completely in software on a DSP. More complex implementations such as multi-standard devices will typically incorporate a lot of the frequency control circuit's functionality on DSPs or ASICs.

The voltage controlled oscillator (VCO) 94, is a standard VCO as known in the art, generating mono-tonal signals in the range dictated by the operating range of the demodulator 70. As well, the control voltage input will have to be compatible with the output of the frequency control circuit 80, but that is a straightforward design matter. In the preferred embodiment described hereinafter the analogue control input to the VCO 82 has a range of 800 mV to 1.15V, which results in a frequency variation of ˜160 MHz to ˜40 MHz on the φ2 output, but these values are completely design dependent.

An exemplary embodiment of the frequency control circuit 80 will now be described with respect to FIGS. 6-10.

An exemplary circuit for the frequency control circuit 80 is presented in the block diagram of FIG. 6. Note that the Pᵢ, Pᵢ₋₁, αᵢ and αᵢ₋₁ signals are digital byte data, while the outputs of the two Sgn functions are either +1 or −1 values. This circuit operates as follows:
1. the initial power at the i^{th} step, Pᵢ, is received and is passed through a delay latch 90, so that an historic power measurement Pᵢ₋₁, (the power at the i-1 step) can be stored;
2. the difference between the current and stored power measurements Pᵢ and Pᵢ₋₁ is then calculated using adder 92;
3. the sign of this difference (either +1 or −1) is then determined using the Sgn(Pᵢ−Pᵢ₋₁) function 94;
4. the output of this Sgn(Pᵢ−Pᵢ₋₁) function 94 is then multiplied with the sign of the difference of the a values, Sgn(αᵢ−αᵢ₋₁) using the multiplier 96;
5. the output of the multiplier 96 is fed to an invertor 98 (at this point the signal is referred to herein as “x”), and then to an optional loop filter 100. The loop filter 100 may be necessary to provided additional stability. Note that x is a bit value which establishes whether αᵢ is to be increased or decreased (this invertor 98 can be removed in some cases);
6. the filtered x signal is then input to an adder 102, where it is added to αᵢ. The initial value of αᵢ is a digital byte or word which corresponds to the desired initial value of the output SO_SEL_RX. The initial a value sets the initial frequency output of the VCO 82;
7. the output of the adder 102, is then delayed by delay latch 104, which becomes the next αᵢ;
8. the αᵢ signal is then delayed again using delay latch 106, to store an historic αᵢ₋₁ value;
9. the difference between αᵢ and αᵢ₋₁ is then calculated using adder 108, and the sign of this difference is taken using the Sgn(αᵢ−αᵢ₋₁) function 110. This generates the Sgn(αᵢ−αᵢ₋₁) signal which is fed-back into the multiplier 96; and
10. as suggested above, a sets the frequency of the VCO 82, so it will generally be converted to an analogue form using the digital to analogue convertor 112, and be fed to the VCO 82. This output signal is labelled SO_SEL_RX in FIG. 6.

As noted above, it will generally be necessary to initialize the values of the signals in the frequency control circuit 80. Typically, a register of some sort can be used to load in appropriate values for the Pᵢ, Pᵢ₋₁, αᵢ₋₁ and αᵢ₋₁ signals. It is possible that the Sgn functions will return zero values if the differences are less than some selected value.

An exemplary operating cycle of this circuit might proceed as follows:

| i | Pᵢ | Pᵢ₋₁ | αᵢ | αᵢ₋₁ | Sgn(Pᵢ − Pᵢ₋₁) | Sgn(αᵢ − αᵢ₋₁) | x |
|---|---|---|---|---|---|---|---|
| initial | 0 | max | 0 | max | −1 | −1 | −1 |
| 1 | 5 | 0 | −1 | 0 | 1 | −1 | 1 |
| 2 | 4 | 5 | 0 | −1 | −1 | 1 | 1 |
| 3 | 3 | 4 | 1 | 0 | −1 | 1 | 1 |
| 4 | 2 | 3 | 2 | 1 | −1 | 1 | 1 |
| 5 | 1 | 2 | 3 | 2 | −1 | 1 | 1 |
| 6 | 0 | 1 | 4 | 3 | −1 | 1 | 1 |
| 7 | 1 | 0 | 5 | 4 | 1 | 1 | −1 |
| 8 | 0 | 1 | 4 | 5 | −1 | −1 | −1 |
| 9 | 1 | 0 | 3 | 4 | 1 | −1 | 1 |
| 10 | 0 | 1 | 4 | 3 | −1 | 1 | 1 |

Note that the x value determines whether the α signal will be incremented or decremented on the next loop. Also note that this loop results in the output to the VCO 82 being incremented one step at a time. This results in a step up or down of 5.5 mV to the VOC 82. This control circuit can easily be altered to result in larger or smaller steps.

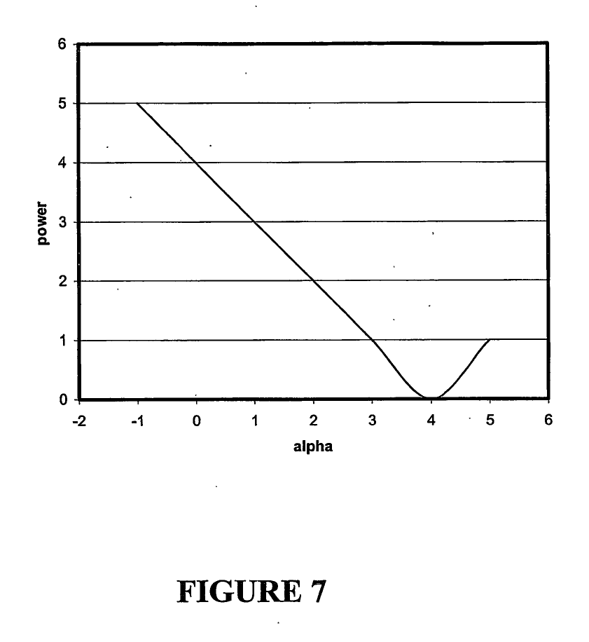

FIG. 7 presents a graph of the relationship between the output power P and control signal α, per the exemplary table above. At startup, the output power P is at a level of 5, and αis at −1. The power level P drops as a rises, power level P being minimized at 0, which corresponds to an α value of 4. The power level P then vacillates between 0 and 1, as a hunts between 3 and 5.

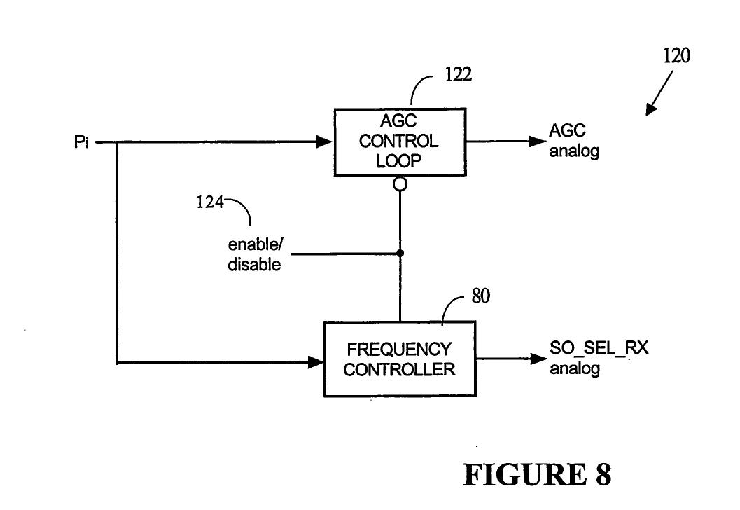

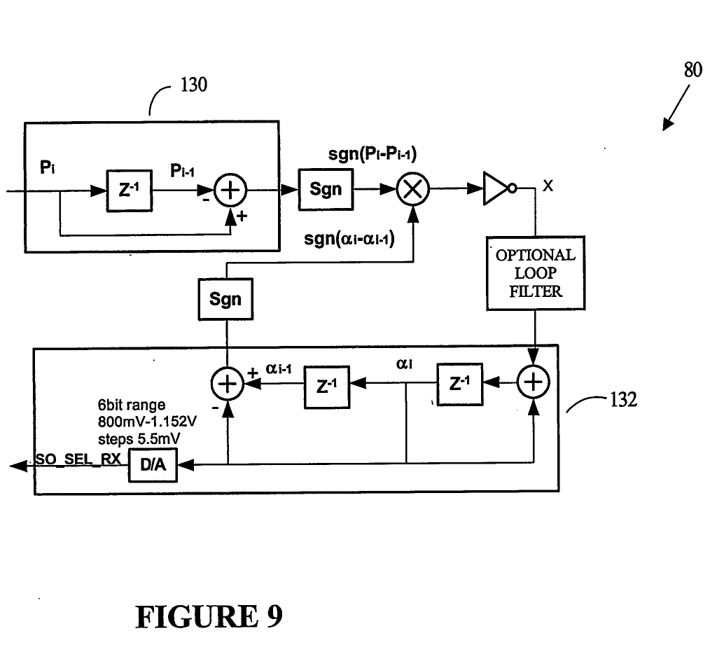

FIGS. 8 and 9 present block diagrams of how the circuit of FIGS. 5 and 6 might be applied.

When starting up, it would be desirable to set the frequency of φ2 at an ideal theoretical level. The circuit 120 of FIG. 5 is used to accomplish this, incorporating an automatic gain control (AGC) loop 122 to set the input to the VCO 82. As shown in FIG. 5, the frequency control circuit 80 and the AGC control loop 122 are connected in parallel, and both receive the power level input Pᵢ. However, the output of only one of these two devices will be fed to the VCO 82, which is controlled by the enable/disable input 124. This enable/disable input 124 can be controlled using a threshold detector, or could be provided by a DSP or similar processing device.

The operation of this circuit 120 preferable proceeds as follows:
1. the AGC control loop 122 is first initialized to find the correct gain; then
2. the AGC control loop 122 is disabled and the frequency control circuit 80 is turned on;
3. if the power at the input to the frequency control circuit 80 goes below some critical value the frequency control circuit 80 is disabled and the AGC control loop 122 is enabled;
4. once a reasonable power level Pᵢ is detected at the input, the frequency control circuit 80 is again enable and the AGC control loop 122 is disabled.
   This process will continue until the frequency control circuit 80 becomes stable.

During operation mode of the circuit, the frequency control circuit 80 can be adjusted, but it is important that the AGC control loop 122 be disabled during this adjustment.

Also note that while the frequency control circuit 80 is deactivated, the values of αᵢ and αᵢ₋₁ should be fixed, while the power values Pᵢ and Pᵢ₋₁ should be continuously updated. The components affected by this are shown in FIG. 9, the components being updated being enclosed in block 130, and the components which should hold there values being enclosed in block 132.

Software Implementation

The invention can be implemented in many forms, incorporating hardware, software, or a combination of the two. The invention could, for example, be implemented in an existing digital signal processor (DSP) with almost no hardware modifications.

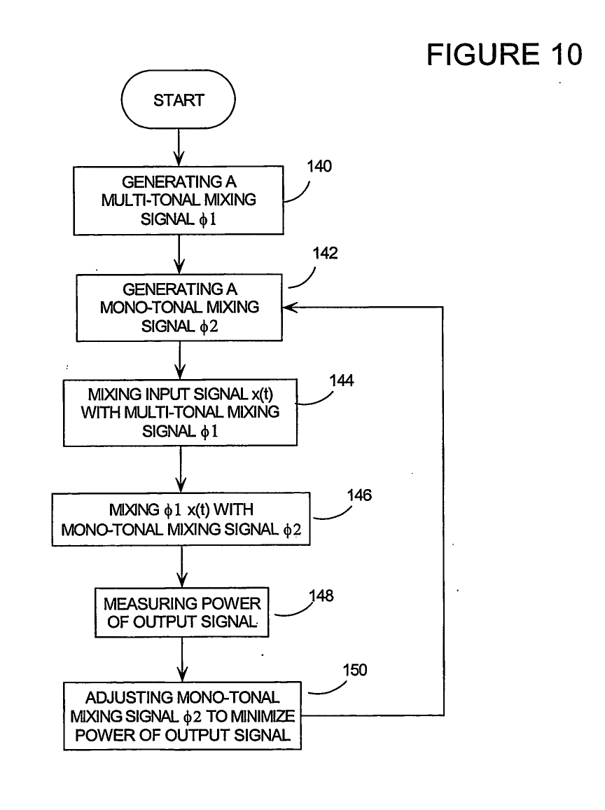

An exemplary methodology is presented in FIG. 10. This methodology is implemented by performing the following steps:
1. generating a multi-tonal mixing signal φ1 at step 140;
2. generating a mono-tonal mixing signal φ2 at step 142, where φ1*φ2 has significant power at the frequency of the local oscillator signal being emulated, and neither of the φ1 nor the φ2 having significant power at the frequency of an input signal x(t), the LO signal being emulated, or an output signal φ1 φ2 x(t);
3. at step 144, mixing the input signal x(t) with the multi-tonal mixing signal φ1, to generate an output signal φ1 x(t);
4. at step 146, mixing the signal φ1 x(t) with the mono-tonal mixing signal φ2, to generate an output signal φ1 φ2 x(t);
5. measuring the power of the output signal φ1 φ2 x(t) at step 148; and
6. adjusting the characteristics of the mono-tonal mixing signal φ2 at step 150 to minimize the power of the output signal φ1 φ2 x(t), and returning to step 142.
   Modifications to this methodology would be clear from a reading of the balance of this document.
   Virtual Local Oscillator Signals

An exemplary set of VLO signals were described hereinabove. The purpose of this section is to present VLO signals in a more general way, as any number of VLO signals could be generated with which the invention could be implemented.

Aperiodic or time-varying mixing signals offer advantages over previously used mono-tonal oscillator signals. A given pair of these virtual local oscillator (VLO) signals φ1 and φ2 have the properties that:
1. their product emulates a local oscillator (LO) signal that has significant power at the frequency necessary to translate the input signal x(t) to the desired output frequency. For example, to translate the input signal x(t) to baseband, φ1 (t)*φ2(t) must have a frequency component at the carrier frequency of x(t); and
2. one of either φ1 and φ2, has minimal power around the frequency of the mixer pair output φ1(t)*φ2(t)*x(t), while the other has minimal power around the centre frequency, f_{RF}, of the input signal x(t). “Minimal power” means that the power should be low enough that it does not seriously degrade the performance of the RF chain in the context of the particular application.

For example, if the mixer pair is demodulating the input signal x(t) to baseband, it is preferable that one of either φ1 and φ2 has minimal power around DC.

As a result, the desired demodulation is affected, but there is no LO signal to leak into the signal path and appear at the output.

As noted above, mixing two signals together generates an output with:
(a) a signal equal in frequency to the sum of the frequencies of the input signals;
(b) a signal equal in frequency to the difference between the frequencies of the input signals; and
(c) the original input frequencies.
   Thus, direct conversion receivers known in the art must mix the input signal x(t) with a LO signal at the carrier frequency of the input signal x(t). If the LO signal of a direct conversion receiver leaks into the signal path, it will also be demodulated to baseband along with the input signal x(t), causing interference. The invention does not use an LO signal, so leakage does not generate a signal at the baseband output φ1(t)*φ2(t)*x(t).

Any signal component at the frequency of the input signal x(t) or output φ1(t)*φ2(t)*x(t), in either of the mixing signals φ1 and φ2, is suppressed or eliminated by the other mixing signal. For example, if the mixing signal φ2 has some amount of power within the bandwidth of the up-converted RF (output) signal, and it leaks into the signal path, then it will be suppressed by the φ1 mixing signal which has minimal power within the bandwidth of the up-converted RF (output) signal. This complementary mixing suppresses interference from the mixing signals φ1 and φ2.

As noted above, current receiver and transmitter technologies have several problems. Direct-conversion transceivers, for example, suffer from LO leakage and 1/f noise problems which limit their capabilities, while heterodyne transceivers require image-rejection techniques which are difficult to implement on-chip with high levels of performance.

The problems of image-rejection, LO leakage and 1/f noise in highly integrated transceivers can be overcome by using the complementary VLO signals. These signals are complementary in that one of the φ1 and φ2 signals has minimal power around the frequency of the output signal y(t) (which is around DC if conversion is to baseband), and the other has minimal power around the centre frequency, f_{RF}, of the input signal x(t).

These signals φ1 and φ2 can, in general, be:
1. random or pseudo-random, periodic functions of time;
2. analogue or digital waveforms;
3. constructed using conventional or non-conventional bipolar waves;
4. averaging to zero;
5. amplitude modulated; and
6. generated in a number of manners including:
   a. being stored in memory and clocked out;
   b. being generated using digital blocks;
   c. being generated using noise shaping elements (e.g. delta-sigma elements); or
   d. being constructed using PN sequences with additional bits inserted so they comply to the above conditions.

It would be clear to one skilled in the art that virtual LO signals may be generated which provide the benefits of the invention to greater or lesser degrees. While it is possible in certain circumstances to have almost no LO leakage, it may be acceptable in other circumstances to incorporate virtual LO signals which still allow a degree of LO leakage.

Virtual local oscillator signals may also be generated in different forms, such as using three or more complementary signals rather than the two mixing signals shown above. These and other variations are described in the following co-pending patent applications:
1. PCT International Application Serial No. PCT/CA00/00995 Filed Sep. 1, 2000, titled: “Improved Method And Apparatus For Up-Conversion Of Radio Frequency (RF) Signals”;
2. PCT International Application Serial No. PCT/CA00/00994 Filed Sep. 1, 2000, titled: “Improved Method And Apparatus For Down-Conversion Of Radio Frequency (RF) Signals”; and
3. PCT International Application Serial No. PCT/CA00/00996 Filed Sep. 1, 2000, titled: “Improved, Method And Apparatus For Up-And-Down-Conversion Of Radio Frequency (RF) Signals”.
   In-Phase and Quadrature Signals

In many modulation schemes, it is necessary to modulate or demodulate both in-phase (I) and quadrature (Q) components of the input signal.

In such a case, four modulation functions would have to be generated: φ1I which is 90 degrees out of phase with φ1Q; and φ2I which is 90 degrees out of phase with φ2Q. The pairing of signals φ1I and φ2I must meet the function selection criteria listed above, as must the signal pairing of φ1Q and φ2Q.

Design of components to generate and manipulate such signals would be clear to one skilled in the art from the description herein. As well, additional details on the generation of such signals are available in the co-pending patent applications filed under PCT International Application Serial Nos. PCT/CA00/00994, PCT/CA00/00995 and PCT/CA00/00996.

### ADVANTAGES OF THE INVENTION

The invention provides many advantages over down convertors known in the art. As noted above, the invention allows spurs to be reduced and moved away from the signal of interest, by minimizing the baseband power with respect to the location of the unwanted power.

The invention also offers the following:
1. minimal 1/f noise;
2. minimal imaging problems;
3. minimal leakage of a local oscillator (LO) signal into the RF output band;
4. has a higher level of integration as the components it does require are easily placed on an integrated circuit. For example, no large capacitors or sophisticated filters are required; and
5. it is well suited to mult-band, multi-standard applications because of the integrated nature of the design. The circuits of the invention can operate effectively with a very wide range of mixing signals φ1 and φ2, and these mixing signals can easily be generated by suitable control components.

A high level of integration results in decreased IC (integrated circuit) pin counts, decreased signal power loss, decreased IC power requirements, improved SNR (signal to noise ratio), improved NF (noise factor), and decreased manufacturing costs and complexity. The design of the invention therefore makes the production of inexpensive multi-standard/multi-frequency communications transmitters and receivers a reality.

The benefits of the invention are most apparent when it is implemented within a single-chip design, eliminating the extra cost of interconnecting semiconductor integrated circuit devices, reducing the physical space they require and reducing the overall power consumption. Increasing levels of integration have been the driving impetus towards lower cost, higher volume, higher reliability and lower power consumer electronics since the inception of the integrated circuit. This invention will enable communications devices to follow the same integration route that other consumer electronic products have benefited from.

Options and Alternatives

A number of variations can be made to the topologies described herein, including the following:
1. the circuits of the invention were described in digital domain. They can also be expressed in analog domain;
2. the Sgn functions 94, 110 can be removed if an appropriate multiplier 96 is used which ignores the irrelevant bits;
3. differential signaling could be used for some or all of the components in this design. Differential signals are signals having positive and negative potentials with respect to ground, rather than a single potential with respect to ground. The use of a differential architecture results in stronger output signals that are more immune to common mode noise.
   The generation of differential VLO signals is straightforward because a given pair of differential VLO signals are simply complements of one another. Adapting φ1 to a differential architecture simply requires the generation of a complementary φ1P and φ1N pair, where φ1P and φ1N are inverses of one another, that is: φ1P=−(φ1N);
4. various mixer designs could be used as known in the art, such as:
   a. single or double-balanced mixers. Single-balanced mixers will generate less noise than double-balanced mixers simply because there are fewer noise contributors in the single-balanced design. However, single-balanced mixers are less immune to external noise, particularly common mode noise;
   b. active or passive mixers;
   c. active mixers with adjustable performance. A suitable active mixer is described in the co-pending patent application filed under Canadian Patent Application Serial No. 2,375,438, titled: “Improvements to a High Linearity Gilbert I Q Dual Mixer”. This mixer has adjustable gain and adjustable current source. Gain-control is provided by means of a number of different input transistors, each being fed with the same input signal. The amount of biasing current is controlled by using a number of current sources which are electronically switched in and out of the circuit as required; and
5. a high pass filter 76 which incorporates a voltage divider, could be used to set the common mode output.

### CONCLUSIONS

It will be apparent to those skilled in the art that the invention can be extended to cope with more than two or three standards, and to allow for more biasing conditions than those in the above description.

The electrical circuits of the invention may be described by computer software code in a simulation language, or hardware development language used to fabricate integrated circuits. This computer software code may be stored in a variety of formats on various electronic memory media including computer diskettes, CD-ROM, Random Access Memory (RAM) and Read Only Memory (ROM). As well, electronic signals representing such, computer software code may also be transmitted via a communication network.

Clearly, such computer software code may also be integrated with the code of other programs, implemented as a core or subroutine by external program calls, or by other techniques known in the art.

The embodiments of the invention may be implemented on various families of integrated circuit technologies using digital signal processors (DSPs), microcontrollers, microprocessors, field programmable gate arrays (FPGAs), or discrete components. Such implementations would be clear to one skilled in the art.

The various preferred implementations in this section are each described in terms of field effect transistors. The implementations are equally advantageous when other technologies are used, including, but not limited to CMOS or Bipolar Junction Transistors. Similarly, suitable fabrication technologies other than Silicon (Si) may be used, including, but not limited to Silicon/Germanium (SiGe), Germanium (Ge), Gallium Arsenide (GaAs), and Silicon on Sapphire (SOS). It is the inventors' intention to protect all such implementations.

The invention may be applied to various communication protocols and formats including: amplitude modulation (AM), frequency modulation (FM), frequency shift keying (FSK), phase shift keying (PSK), cellular telephone systems including analogue and digital systems such as code division multiple access (CDMA), time division multiple access (TDMA) and frequency division multiple access (FDMA).

The invention may be applied to such applications as wired communication systems include computer communication systems such as local area networks (LANs), point to point signalling, and wide area networks (WANs) such as the Internet, using electrical or optical fibre cable systems. As well, wireless communication systems may include those for public broadcasting such as AM and FM radio, and UHF and VHF television; or those for private communication such as cellular telephones, personal paging devices, wireless local loops, monitoring of homes by utility companies, cordless telephones including the digital cordless European telecommunication (DECT) standard, mobile radio systems, GSM and AMPS cellular telephones, microwave backbone networks, interconnected appliances under the Bluetooth standard, and satellite communications.

While particular embodiments of the present invention have been shown and described, it is clear that changes and modifications may be made to such embodiments without departing from the true scope and spirit of the invention.

1. A demodulator circuit for emulating the down conversion of an input signal x(t) with a local oscillator (LO) signal, said demodulator circuit comprising:
a first mixer for receiving said input signal x(t), and mixing said input signal x(t) with a multi-tonal mixing signal φ1, to generate an output signal φ1 x(t);
a second mixer for receiving said signal φ1 x(t) as an input, and mixing said signal φ1 x(t) with a mono-tonal mixing signal φ2, to generate an output signal φ1 φ2 x(t);
a first signal generator for generating said multi-tonal mixing signal φ1;
a second signal generator for generating said mono-tonal mixing signal φ2, where φ1*φ2 has significant power at the frequency of said local oscillator signal being emulated; and
a power measurement circuit for measuring the power of said output signal φ1 φ2 x(t);
said second signal generator receiving a power level signal output from said power measurement circuit, and varying the characteristics of said mono-tonal mixing signal φ2 to reduce the power level of said output signal φ1 φ2 x(t).

2. The circuit of claim 1 wherein said second signal generator varies the frequency of said φ2 signal.

3. The circuit of claim 2 wherein said second signal generator comprises a voltage controlled oscillator (VCO).

4. The circuit of claim 3 wherein said second signal generator comprises:
a means for detecting changes in output power over time; and
a frequency control circuit which directs said VCO to incrementally adjust the frequency of said φ2 signal in response to changes in output power over time.

5. The circuit of claim 4 wherein said frequency control circuit responds to a failing trend in said power level over time by directing said VCO to continue adjusting the frequency of said φ2 signal in the same manner that it has been.

6. The circuit of claim 4 wherein said frequency control circuit responds to a rising trend in said power level over time by directing said VCO to invert the sense of the incremental adjustments being made to the frequency of said φ2 signal.

7. The circuit of claim 4 wherein said frequency control circuit further comprises means for smoothing changes in values of said output power, improving stability.

8. The circuit of claim 4 wherein said means for detecting changes in output power comprises:
a power measurement device with digital output;
a time delay device for receiving said digital output from said power measurement device and delaying said digital output; and
a comparator for comparing a current digital output to a delayed digital output, thereby determining whether power level is rising or falling over time.

9. The circuit of claim 5 further comprising a means for setting initial conditions of said frequency control circuit.

10. The circuit of claim 5 further comprising a clock which establishes timing for sampling and processing of output power signals for said frequency control circuit.

11. The circuit of claim 2 wherein neither of said φ1 nor said φ2 signals have significant power at the carrier frequency of said input signal x(t).

12. The circuit of claim 11 wherein neither of said φ1 nor said φ2 signals have significant power at the carrier frequency of said LO signal being emulated.

13. The circuit of claim 1 wherein said first signal generator comprises a signal generator for generating square wave signals.

14. The circuit of claim 1 wherein said second signal generator comprises a signal generator for generating square wave signals.

15. The circuit of claim 1 wherein unwanted power at baseband is minimized by adjusting the frequency of said φ2 signal such that unwanted RF tones do not fall within the frequency range of the desired signal at baseband.

16. The circuit of claim 1 wherein unwanted power at baseband is minimized by adjusting the frequency of said φ2 signal so that the probability of unwanted RF tones falling within the frequency range of φ1*φ2 x(t) is significantly reduced.

17. The circuit of claim 1 wherein said second signal generator varies the phase of said φ2 signal.

18. The circuit of claim 1 wherein said second signal generator is responsive to noise in said output signal φ1 φ2 x(t) by adjusting the frequency of φ2.

19. The circuit of claim 3 wherein said first mixer comprises an active mixer.

20. The circuit of claim 19 wherein said first mixer comprises an active mixer having adjustable performance.

21. The circuit of claim 19 further comprising a high pass filter electrically connected between said first mixer and said second mixer.

22. The circuit of claim 21 wherein said second mixer comprises a passive mixer.

23. The circuit of claim 22, wherein each of said active mixer, said high pass filter and said passive mixer is a differential device.

24. A method of emulating the demodulation of an input signal x(t) to the product of said input signal with a local oscillator (LO) signal, said method comprising the steps of:
generating a multi-tonal mixing signal φ1;
generating a mono-tonal mixing signal φ2, where φ1*φ2 has significant power at the frequency of the local oscillator signal being emulated, and neither of said φ1 nor said φ2 having significant power at the frequency of said input signal x(t), said LO signal being emulated, or an output signal φ1 φ2 x(t);
mixing said input signal x(t) with said multi-tonal mixing signal φ1, to generate an output signal φ1 x(t);
mixing said signal φ1 x(t) with said mono-tonal mixing signal φ2, to generate said output signal φ1 φ2 x(t);
measuring the power of said output signal φ1 φ2 x(t); and
adjusting the characteristics of said mono-tonal mixing signal φ2 to minimize the power of said output signal φ1 φ2 x(t).

25. A computer readable memory medium for storing software code executable to perform the method steps of claim 24.

26. (canceled)
